(19) United States
(12) Patent Application Publication
(10) Pub. No.: US 2019/0391734 A1
(43) Pub. Date: Dec. 26, 2019

(54) SYSTEM FOR CONTROL OF PUBLIC ANNOUNCEMENTS

(71) Applicants: Jesse Baptiste, Springfield Gardens, NY (US); Michael A. Leonetti, Long Beach, NY (US)

(72) Inventors: Jesse Baptiste, Springfield Gardens, NY (US); Michael A. Leonetti, Long Beach, NY (US)

(21) Appl. No.: 16/446,799

(22) Filed: Jun. 20, 2019

Related U.S. Application Data
(60) Provisional application No. 62/687,246, filed on Jun. 20, 2018.

(51) Int. Cl. G06F 3/0484; H04R 27/00; G06F 3/0482; G06F 3/16; G06F 3/0488; G10L 13/04

(52) U.S. Cl. CPC G06F 3/04847; H04R 27/00; G10L 13/043; G06F 3/165; G06F 3/04883; G06F 3/0482

(57) ABSTRACT

A system may be provided for controlling one or more public address (PA) systems and bell schedules with a computerized device. The computerized device is optionally a mobile device. One or more PA systems may be grouped together in order to play announcements on all PA systems in the group. Interface elements of the system may allow making an announcement using a push to talk feature. PA systems may comprise one or more smartboards that include speakers and also act as interactive whiteboards.

### CROSS-REFERENCE TO RELATED APPLICATIONS

This application claims the benefit of U.S. Provisional Patent Application No. 62/687,246, filed Jun. 20, 2018, which is hereby incorporated by reference in its entirety.

### FIELD OF THE INVENTION

The present invention relates to generally to controlling public announcements or bell schedules via a computer system.

### BACKGROUND

Public address (PA) systems are used in locales from schools to event centers to hospitals and others. However, these PA systems still use old, non-networked technology that do not allow easy access from mobile systems or other computerized devices. Instead, PA systems are traditionally self-contained and must be used with specialized microphones and loudspeakers. The lack of interoperability renders these PA systems rigid and inflexible. For example, a staff member who wishes to make an announcement often needs to be in a centralized location, such as a main office, in order to make an announcement.

It would be desirable to use networking and software techniques to allow access to a PA system and other systems, like bell schedules, from mobile devices and remote computers.

### SUMMARY OF THE INVENTION

Some embodiments relate to the use of a mobile device or remote computer system to make announcements on one or more PA systems. In some embodiments, multiple distinct PA systems may be grouped using network to allow a single announcement to be broadcast in multiple locales.

In some embodiments, previously recorded announcements may be replayed. New announcements may also be made using a computerized device. A push to talk feature may allow the user to start recording using a first user interaction and to stop recording using a second user interaction.

In some embodiments, a bell schedule may be interactively set using a software interface. The software interface may display existing bells and allow the user to change the times that the bells will ring.

In some embodiments, smartboards, which are interactive whiteboards, may be linked to provide a dynamic PA system by using the smartboard speaker systems. The smartboards may allow two way communication using an intercom-like system or video conferencing.

### BRIEF DESCRIPTION OF THE DRAWINGS

FIG. 1 illustrates an exemplary network environment where some embodiments of the invention may operate.

FIGS. 2A-B illustrate an exemplary method that may be performed according to some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Embodiments of the invention may comprise one or more computers. Embodiments of the invention may comprise software and/or hardware. Some embodiments of the invention may be software only and may reside on hardware. A computer may be special-purpose or general purpose. A computer or computer system includes without limitation electronic devices performing computations on a processor or CPU, personal computers, desktop computers, laptop computers, mobile devices, cellular phones, smart phones, PDAs, pagers, multi-processor-based devices, microprocessor-based devices, programmable consumer electronics, cloud computers, tablets, minicomputers, mainframe computers, server computers, microcontroller-based devices, DSP-based devices, embedded computers, wearable computers, electronic glasses, computerized watches, and the like. A computer or computer system further includes distributed systems, which are systems of multiple computers (of any of the aforementioned kinds) that interact with each other, possibly over a network. Distributed systems may include clusters, grids, shared memory systems, message passing systems, and so forth. Thus, embodiments of the invention may be practiced in distributed environments involving local and remote computer systems. In a distributed system, aspects of the invention may reside on multiple computer systems.

Embodiments of the invention may comprise computer-readable media having computer-executable instructions or data stored thereon. A computer-readable media is physical media that can be accessed by a computer. It may be non-transitory. Examples of computer-readable media include, but are not limited to, RAM, ROM, hard disks, flash memory, DVDs, CDs, magnetic tape, and floppy disks.

Computer-executable instructions comprise, for example, instructions which cause a computer to perform a function or group of functions. Some instructions may include data. Computer executable instructions may be binaries, object code, intermediate format instructions such as assembly language, source code, byte code, scripts, and the like. Instructions may be stored in memory, where they may be accessed by a processor. A computer program is software that comprises multiple computer executable instructions.

A database is a collection of data and/or computer hardware used to store a collection of data. It includes databases, networks of databases, and other kinds of file storage, such as file systems. No particular kind of database must be used. The term database encompasses many kinds of databases such as hierarchical databases, relational databases, post-relational databases, object databases, graph databases, flat files, spreadsheets, tables, trees, and any other kind of database, collection of data, or storage for a collection of data.

A network comprises one or more data links that enable the transport of electronic data. Networks can connect computer systems. The term network includes local area network (LAN), wide area network (WAN), telephone networks, wireless networks, intranets, the Internet, and combinations of networks.

In this patent, the term “transmit” includes indirect as well as direct transmission. A computer X may transmit a message to computer Y through a network pathway including computer Z. Similarly, the term “send” includes indirect as well as direct sending. A computer X may send a message to computer Y through a network pathway including computer Z. Furthermore, the term “receive” includes receiving indirectly (e.g., through another party) as well as directly. A computer X may receive a message from computer Y through a network pathway including computer Z.

Similarly, the terms “connected to” and “coupled to” include indirect connection and indirect coupling in addition to direct connection and direct coupling. These terms include connection or coupling through a network pathway where the network pathway includes multiple elements.

To perform an action “based on” certain data or to make a decision “based on” certain data does not preclude that the action or decision may also be based on additional data as well. For example, a computer performs an action or makes a decision “based on” X, when the computer takes into account X in its action or decision, but the action or decision can also be based on Y.

In this patent, “computer program” means one or more computer programs. A person having ordinary skill in the art would recognize that single programs could be rewritten as multiple computer programs. Also, in this patent, “computer programs” should be interpreted to also include a single computer program. A person having ordinary skill in the art would recognize that multiple computer programs could be rewritten as a single computer program.

The term computer includes one or more computers. The term computer system includes one or more computer systems. The term computer server includes one or more computer servers. The term computer-readable medium includes one or more computer-readable media. The term database includes one or more databases.

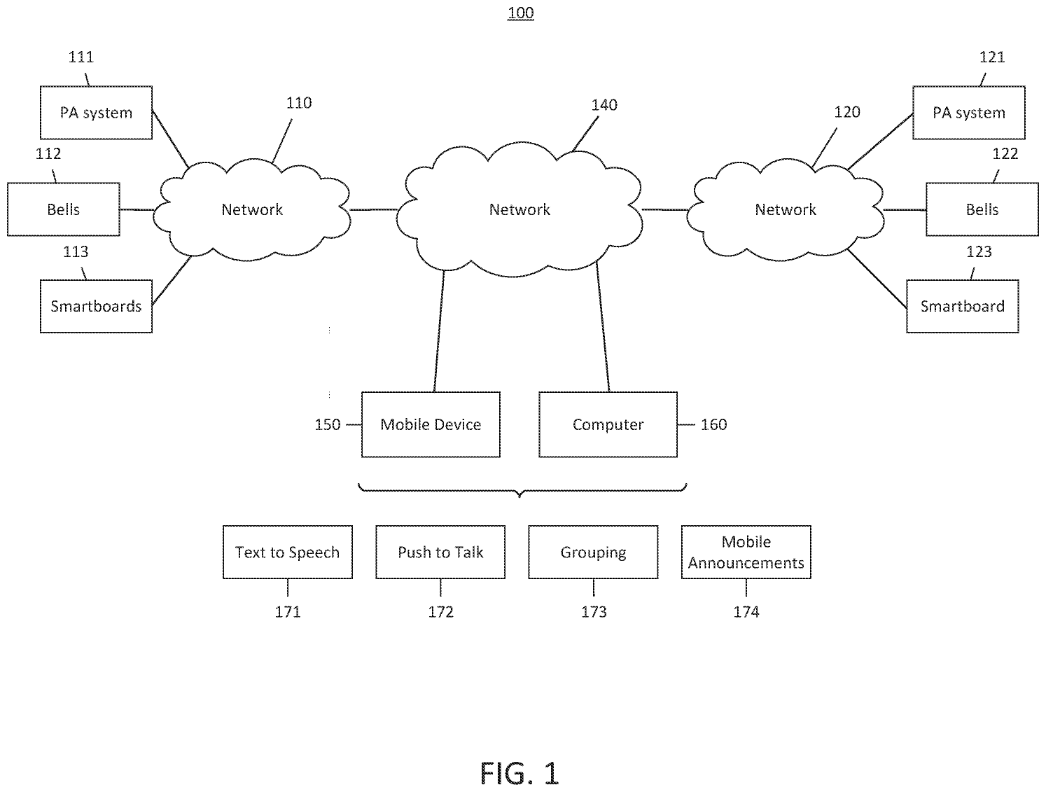

FIG. 1 illustrates an exemplary network environment 100 where some embodiments of the invention may operate. The network environment may include a network 140. Network 140 may comprise a local area network (LAN), wide area network (WAN), telephone network, such as the Public Switched Telephone Network (PSTN), an intranet, the Internet, combinations of networks, or other networks.

Network 110 and network 120 may comprise two subnetworks, otherwise known as subnets, of the network 140. A subnetwork is a network that is a subset of a larger network. For example, the networks 110, 120 may each comprise a subset of IP addresses on the larger network 140.

In some embodiments, networks 110, 120 are intranets that use a distinct network addressing system from network 140. In this embodiment, network addresses on networks 110, 120 cannot directly access each other using a single network addressing system. Instead, requests from a device on network 110 that desires to access a device on network 120 must go through a gateway from network 110 to network 140 and then a gateway from network 140 to network 120. The gateways perform address translation from the addressing scheme of one network to another.

Intranets and subnetworks may also include security systems that filter or block some requests coming from outside the network. Meanwhile, requests coming from inside the intranet or subnetwork may be subject to fewer security restrictions.

In the network environment 100, the networks 110, 120 each provide connectivity for a locale with a PA system, bell system, and one or more smartboards. The locale may be a school, community center, event center, temporary event location, or any other locale. PA system 111, bell system 112, and smartboards 113 are connected on network 110, and PA system 121, bell system 122, and smartboards 123 are connected on network 120. A PA system is a system for making public announcements and comprises speakers for broadcasting an announcement in multiple rooms or locations. A bell system is a system for ringing bells, such as for identifying the beginning or end of classes or events. In some embodiments, physical bells are used and in other embodiments electronically recorded bell sounds are used.

Smartboards are interactive whiteboards and may serve a similar purpose to that performed by older technologies like blackboards and projectors. A smartboard is a computerized device and may include a processor, memory, and storage. A smartboard allows display of screens and images from a communicably connected computer system. The computer system may be connected to the smartboard through a wired or wireless connection.

In one embodiment smartboard comprises a large LCD screen that displays content. The LCD screen may include a touchscreen that allows mark up of the displayed screen or image. In response to a touch event on the screen, the smartboard processor may display a mark at the location of the touch event. Touch events may be recorded in response to touches by a finger or body part or in response to specialized devices like virtual markers or pointers. In this manner, the smartboard may allow for free drawing on the screen in a similar manner to blackboards and projector overlays.

In another embodiment, the smartboard comprises a projection system. The projection system receives an image or screen to display from the communicably connected computer system. The projection system then projects the image or screen on to a screen. The screen may be a discrete device such as foldable or rollable screen or may be a wall or whiteboard. Touch events on the smartboard may be recorded using a computer vision system watching for touch events on the screen. The smartboard may record touch events, as described above, store them in memory, and project mark up on the screen to display mark up at the touch events.

Smartboard 113, 123 may also have speakers for playing audio. In some embodiments, smartboards 113, 123 may be part of a PA systems 111, 121, respectively. For example, announcements transmitted for announcement on PA systems 111, 121 may also be played by the speakers on smartboards 113, 123. In some embodiments, the speakers on smartboards 113, 123 are loudspeakers or intercoms.

Smartboards 113, 123 may also have a microphone to recording audio. The audio recorded by the microphone on smartboards 113, 123 may be stored in the local memory of the smartboard or transmitted to other computer systems. In one embodiment, smartboards 113, 123 may display an interface to make public announcements using an application. The microphone may be used to record the public announcement and play it on other smartboards 113, 123 or on PA systems 111, 121.

Moreover, smartboards 113, 123 may be used as a video conferencing system to connect with other smartboards or other computer systems. Video conferencing may be performed between staff members and other staff members or between staff members and parents. Smartboards 113, 123 may display video of a remote participant at a remote computer and video of the local participant, which is also transmitted to the remote participant. Moreover, the smartboards 113, 123 may play audio from the remote participant and transmit locally collected audio to the remote participant.

Network environment 100 also includes a mobile device 150 and a non-mobile computer system 160. The mobile device 150 and non-mobile computer system 160 may each run a software application that allows control of various features of the other devices in the network environment 100, including the PA systems 111, 121, bell systems 112, 122, and smartboards 113, 123.

The software application may include a text to speech system 171. The text to speech system accepts text input and uses speech synthesis to generate an audio speech file from the text. The synthesized audio file may be played as an announcement.

The software application may include push to talk system 172. The push to talk system 172 may display user interface elements allowing the user to press an interface component to begin recording and press the same or different interface component to stop recording. During the recording period, audio is collected from a microphone and stored. The recorded audio may be played as an announcement.

The software application may include grouping system 173. The grouping system 173 may display user interface elements for grouping multiple PA systems into a single PA system group. The PA system group may then act like a single PA system that can receive and make announcements to all the PA systems in the group using only a single command. The grouping system 173 may also allow for ungrouping PA systems or removing individual PA systems from groups.

The software application may include mobile announcements system 174. The mobile announcements system 174 may allow the user to opt to send announcements made via the application to one or more mobile subscribers via mobile delivery, such as SMS message, IP text message, or other messaging systems. Mobile announcements system 174 may include functionality to create groups of mobile users for receiving mobile announcements. In response to a request to add users to a group of mobile subscribers, the mobile announcements system 174 may add users to the group of mobile subscribers. In response to a request to delete users from a group of mobile subscribers, the mobile announcements system 174 may remove users from the group of mobile subscribers. If the sending of announcements to mobile subscribers via mobile delivery is selected, then software application may save an announcement as an audio file and transmit the audio file to one or more mobile devices or non-mobile devices of the group of mobile subscribers over a communication channel, such as a wired or wireless connection.

In some embodiments, the software application may store a plurality of distinct groups of mobile subscribers. Announcements may be sent to a selected one or more of the groups of mobile subscribers at one time.

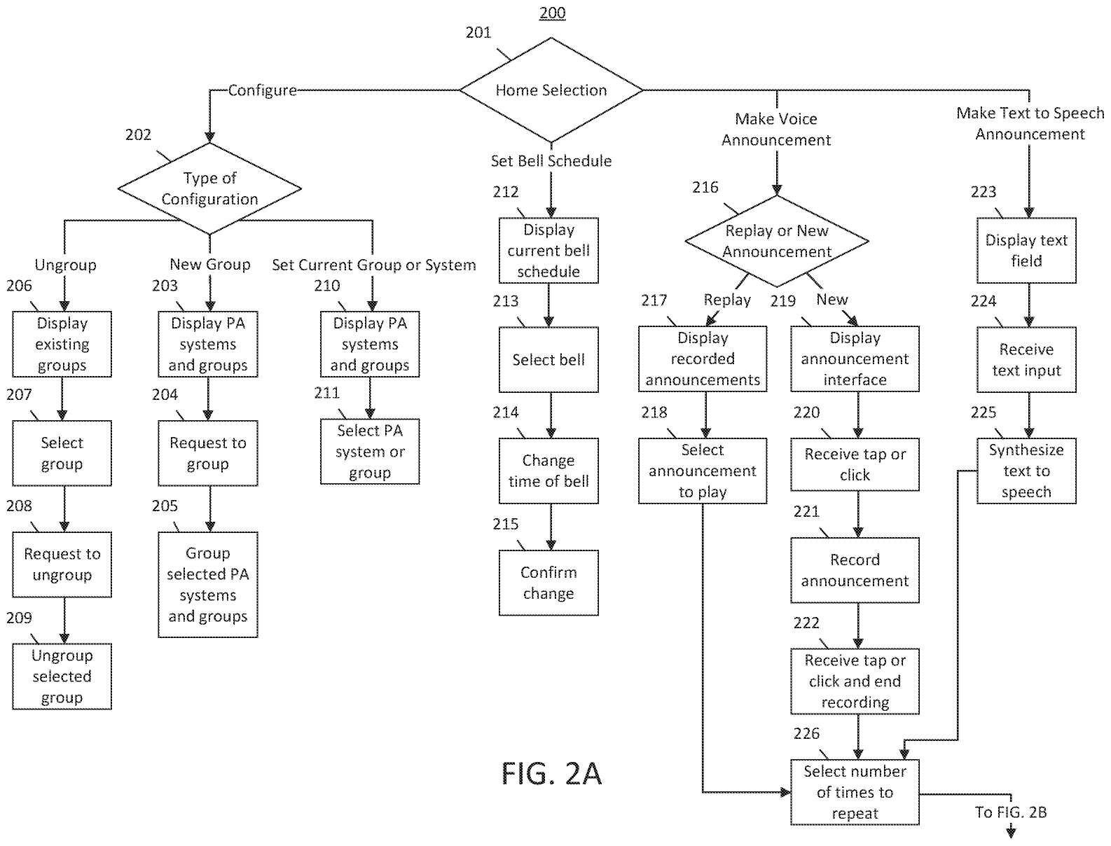

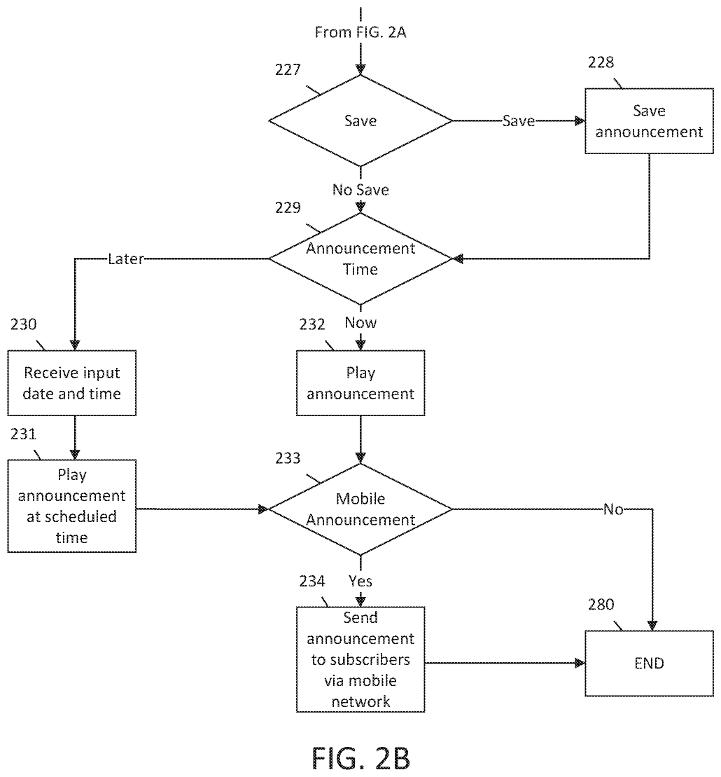

FIGS. 2A-B illustrate an exemplary method 200 that may be performed in some embodiments via a software application on a computer system, such as software application operating on mobile device 150 or non-mobile computer system 160. In step 201, a home selection screen may be displayed, which presents the user with a set of options of what action to perform. Displayed options may include configuration, setting a bell schedule, making an announcement, or making an announcement using text to speech.

In step 202, if a request is received from a user to perform configuration, then the software application may display set of options for which elements to be configured. Configuration options may include creating new groups, ungrouping, or setting a current group or system.

In step 203, if a request is received from a user to create a new group, then the software application may display a list of PA systems and existing groups. Some of the PA systems and groups may be on different subnets or intranets. Moreover, some of the PA systems may include one or more smartboards in addition to traditional PA loudspeakers. In step 204, a request may be received from a user to group one or more of the PA systems or existing groups. In step 205, the software application may group the selected PA systems and groups to create a new group, where the new group comprises the selected PA systems and the PA systems in the selected groups.

In step 206, in response to a request from a user to ungroup PA systems, the software application may display a list of existing groups of PA systems. In step 207, a selection of a group of PA systems may be received from the user. In step 208, a request to ungroup may be received from the user. In step 209, the software application may ungroup the selected group so that the selected group is deleted and the PA systems in that group become identified as individual PA systems.

In step 210, in response to a request from a user to set the current group of PA system, the software application may display a list of PA systems and groups. In step 211, a selection may be received from the user of a PA system or a group. The software application set the selected PA system or group as the current PA system or group for future announcements.

In step 212, in response to request from the user to set a bell schedule, the software application may display the current bell schedule. The current bell schedule may include one or more bells and the times that the bells are programmed to ring. In step 213, a selection of a bell by the user may be received, resulting in selection of the bell. In step 214, a request may be received from the user to change the time of the bell. A new time for the bell may be received from the user. The software application may change the time that the selected bell is programmed to ring to the new time input by the user. In step 215, the software application may prompt for confirmation of the changed time of the bell. In response to receiving confirmation of the changed time, the software application may store the new time for the bell to ring and cause the bell to ring at that time.

In some embodiments, the software application may display user interface elements for adding or deleting bells from a bell schedule. In response to a request to add a bell or delete a bell, the bell may be added or deleted, respectively.

In step 216, in response to a request from the user to make an announcement, the software application may display an option to the user to replay an old announcement or record a new announcement. In step 217, in response to receiving a request from the user to play an old announcement, the software application may display a list of previously recorded announcements. In step 218, a selection of an announcement from the list of previously recorded announcements may be received.

In step 219, in response to a request from the user to make a new announcement, the software application may display an announcement interface. The announcement interface may include one or more interface components for recording an announcement. It may include, for example, a record and stop recording button. In some cases, the record button and stop recording button are the same button.

In some embodiments, a push to talk feature is provided where a single button is used to begin recording and the same button is used to end recording.

In step 220, a tap or click is received from the user. The tap or click may be received on a defined user interface element such as a button.

In step 221, in response to the tap or click, the software application begins recording an announcement.

In step 222, a tap or click is received from the user, which may be received on the same user interface element as in step 220. In response to this tap or click, the software application stops recording.

In step 223, in response to a request from the user to make an announcement using text to speech, the software application may display a text field. In step 224, the software application may receive text input in the text field. In step 225, a speech synthesis system may be used to convert the text input from the user into an audio file representing the words input by the user in spoken format by a synthesized computer voice.

Step 226 may follow the steps 218, 222, and 225 where an audio file for playing as an announcement is recorded, selected, or synthesized. In step 226, a display is presented for the user to select the number of times to repeat the announcement. It may be desirable to repeat important announcements two or more times. Any number or repetitions may be selected by the user. In response to the selection of the number of times to repeat the announcement, the announcement will be played the selected number of times.

In step 227, an option to save the recorded, synthesized, or selected announcement is displayed. In response to receiving a selection from the user to save the announcement, the announcement is saved in step 228. If the user opts not to save, then the announcement is not saved.

In step 229, an option to play the announcement now or at a later time is displayed to the user.

In step 230, in response to a request from the user to play the announcement later, the software application may display input elements to receive a date and time. The software application may store the date and time received from the user.

In step 231, the software application may play the announcement at the date and time selected by the user. The announcement may be played on the currently selected PA system or the PA systems of the selected group of PA systems, which is set by configuration (see step 211).

In step 232, in response to a request from the user to play the announcement now without delay, the announcement is played. The announcement may be played on the currently selected PA system or the PA systems of the selected group of PA systems, which is set by configuration (see step 211).

During steps 231, 232, the software application may display an option to stop playing the announcement, while the announcement is playing. If a request to stop the announcement is received, then the software application may stop the playing of the recorded announcement before the announcement has completed.

In step 233, the software application may check the current system configuration to determine if configuration has been set to send mobile announcements. If mobile announcements have been set, then the software application may determine a group of mobile subscribers to send announcements to based on the current configuration. The software application may send the present announcement as an audio file to one or more mobile devices of the group of mobile subscribers over a mobile wireless connection.

If mobile announcements have not been set, then the software application does not send out the mobile announcements. The method ends at step 280.

In some embodiments, the bell system may also use the grouping feature. One or more bell systems may be connected with PA systems. When PA systems are grouped together into a PA system group, the connected bell systems may also be grouped. The grouped bell systems may then have a shared bell schedule where a single bell schedule applies to all of the grouped bell systems. Modifying, adding, or deleting a bell from the bell schedule would then affect all the grouped bell systems.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects. Rather, the scope of the invention should be determined with reference to patent claims.

1. A non-transitory computer-readable medium comprising computer-executable instructions for making a public announcement on a public address (PA) system, the computer-readable medium comprising instructions for:
receiving a request to group a plurality of PA systems located on different subnets;
grouping the plurality of PA systems into a new PA system group;
displaying a list of selectable PA system groups and receiving a selection of the new PA system group;
receiving a request to make an announcement;
displaying an option to replay a saved announcement or record a new announcement;
in response to a request to record a new announcement, displaying an announcement recording interface;
receiving a single user interface action of a first type to begin recording;
receiving a single user interface action of a second type to end recording, where the first type of single user interface action is the same as the second type of user interface action;
displaying an option to play the recorded announcement now or later;
in response to a request to play the recorded announcement now, playing the recorded announcement on the PA systems in the selected new PA system group.

2. The non-transitory computer-readable medium of claim 1, further comprising instructions for:
displaying an option to stop the recorded announcement, while the recorded announcement is playing;
in response to a request to stop the recorded announcement, stopping the playing of the recorded announcement.

3. The non-transitory computer-readable medium of claim 1, wherein the new PA system group comprises at least one smart board, the at least one smart board displaying an image from a communicably connected computer system, the at least one smart board including a touch interface for marking up the image in response to touch commands.

4. The non-transitory computer-readable medium of claim 1, further comprising instructions for:
displaying a bell schedule, the bell schedule comprising one or more bells and times that the bells are programmed to ring;
in response to a request to select a bell, selecting the bell;
in response to receiving a user input time, changing the time that the selected bill is programmed to ring to a new time.

5. The non-transitory computer-readable medium of claim 1, further comprising:
in response to a request to play the recorded announcement later, displaying user interface elements for the selection of a later time;
playing the recorded announcement on the PA systems in the selected new PA system group at the later time.

6. The non-transitory computer-readable medium of claim 1, further comprising instructions for:
displaying an option to input an announcement via text input;
in response to a request to input an announcement via text input, displaying a text field for receiving text;
receiving text input from the user in the text field;
converting the received text input into a synthesized speech audio file using speech synthesis;
playing the synthesized speech audio file on the PA systems in the selected new PA system group.

7. The non-transitory computer-readable medium of claim 1, further comprising instructions for:
displaying an option to send announcements to a group of mobile subscribers;
in response to a request to add users to the group of mobile subscribers, adding users to the group of mobile subscribers;
in response to a request to delete users from the group of mobile subscribers, removing users from the group of mobile subscribers;
sending the recorded announcement as an audio file to one or more mobile devices of the mobile subscribers over a mobile wireless connection.

8. The non-transitory computer-readable medium of claim 1, wherein the announcement recording interface is for display on a mobile device.

9. A computer system for making a public announcement on a public address (PA) system, the computer system comprising:
a processor;
a memory, the memory comprising instructions for:
receiving a request to group a plurality of PA systems located on different subnets;
grouping the plurality of PA systems into a new PA system group;
displaying a list of selectable PA system groups and receiving a selection of the new PA system group;
receiving a request to make an announcement;
displaying an option to replay a saved announcement or record a new announcement;
in response to a request to record a new announcement, displaying an announcement recording interface;
receiving a single user interface action of a first type to begin recording;
receiving a single user interface action of a second type to end recording, where the first type of single user interface action is the same as the second type of user interface action;
displaying an option to play the recorded announcement now or later;
in response to a request to play the recorded announcement now, playing the recorded announcement on the PA systems in the selected new PA system group.

10. The computer system of claim 9, wherein the memory further comprises instructions for:
displaying an option to stop the recorded announcement, while the recorded announcement is playing;
in response to a request to stop the recorded announcement, stopping the playing of the recorded announcement.

11. The computer system of claim 9, wherein the new PA system group comprises at least one smart board, the at least one smart board displaying an image from a communicably connected computer system, the at least one smart board including a touch interface for marking up the image in response to touch commands.

12. The computer system of claim 9, wherein the memory further comprises instructions for:
displaying a bell schedule, the bell schedule comprising one or more bells and times that the bells are programmed to ring;
in response to a request to select a bell, selecting the bell;
in response to receiving a user input time, changing the time that the selected bill is programmed to ring to a new time.

13. The computer system of claim 9, wherein the memory further comprises instructions for:
in response to a request to play the recorded announcement later, displaying user interface elements for the selection of a later time;
playing the recorded announcement on the PA systems in the selected new PA system group at the later time.

14. The computer system of claim 9, wherein the memory further comprises instructions for:
displaying an option to input an announcement via text input;
in response to a request to input an announcement via text input, displaying a text field for receiving text;
receiving text input from the user in the text field;
converting the received text input into a synthesized speech audio file using speech synthesis;
playing the synthesized speech audio file on the PA systems in the selected new PA system group.

15. The computer system of claim 9, wherein the memory further comprises instructions for:
displaying an option to send announcements to a group of mobile subscribers;
in response to a request to add users to the group of mobile subscribers, adding users to the group of mobile subscribers;
in response to a request to delete users from the group of mobile subscribers, removing users from the group of mobile subscribers;
sending the recorded announcement as an audio file to one or more mobile devices of the mobile subscribers over a mobile wireless connection.

16. The computer system of claim 9, wherein the announcement recording interface is for display on a mobile device.

17. A non-transitory computer-readable medium comprising computer-executable instructions for setting a bell schedule, the computer-readable medium comprising instructions for:
receiving a request to group a plurality of PA systems located on different subnets;
grouping the plurality of PA systems into a new PA system group;
displaying a list of selectable PA system groups and receiving a selection of the new PA system group;
receiving a request to set a bell schedule;
displaying the bell schedule, the bell schedule comprising one or more bells and times that the bells are programmed to ring;
in response to a request to select a bell, selecting the bell;
in response to receiving a user input time, changing the time that the selected bill is programmed to ring to a new time;
causing the selected bell to ring at the new time in one or more bell systems connected to the PA systems in the new PA system group.

18. The non-transitory computer-readable medium of claim 17, wherein the new PA system group comprises at least one smart board, the at least one smart board displaying an image from a communicably connected computer system, the at least one smart board including a touch interface for marking up the image in response to touch commands.

19. The non-transitory computer-readable medium of claim 17, further comprising instructions for displaying the bell schedule on a mobile device.

20. The non-transitory computer-readable medium of claim 17, further comprising instructions for:
displaying user interface elements for deleting a bell;
in response to receiving a request to delete a bell, deleting the bell.
